(19) United States
(12) Patent Application Publication
(10) Pub. No.: US 2017/0138760 A1
(43) Pub. Date: May 18, 2017

(54) METHOD FOR DERIVING AN ABSOLUTE MULTITURN ROTATIONAL ANGLE OF A ROTATING SHAFT, AND A DEVICE THEREFORE

(71) Applicant: ALLIED MOTION STOCKHOLM AB, Bromma (SE)

(72) Inventor: Erik OLSEN, Hasselby (SE)

(21) Appl. No.: 15/300,036

(22) PCT Filed: Mar. 27, 2015
(86) PCT No.: PCT/SE2015/050372

§ 371 Date: Sep. 28, 2016

(30) Foreign Application Priority Data
Mar. 28, 2014 (SE) 1450367-6

(51) Int. Cl. G01D 5/12; B62D 5/00; B62D 15/02

(52) U.S. Cl. CPC G01D 5/12; B62D 15/0215; B62D 15/0225; B62D 5/008; B62D 5/001; B66F 9/07568

(57) ABSTRACT

A method and device for deriving an absolute multiturn rotational angle of a rotating shaft (19), wherein sensors are arranged to sense the absolute rotational angles of wheels (14, 15, 18) or shafts (13, 16, 19) in a power transmission line having an non-integer gear ratio between the wheels/shafts, and wherein the power transmission line includes a gearbox (11) having multiple stages and wherein the rotational angle is sensed on multiple wheels (14, 15, 18) or shafts (13, 16, 19) in different stages, whereby an absolute multiturn rotational angle of the output shaft from the transmission line is derived by sensing the rotational angles of at least three wheels (14, 15, 18) or shafts (13, 16, 19) in different stages, and analyzing the combination of the sensed angles of the wheels or shafts and thereby deriving the absolute multiturn rotational angle based on the rotational angles read by the sensors.

The present invention relates to a method for deriving an absolute multiturn rotational angle of a rotating shaft, meaning that not only the angle of the shaft is derived, but also the number of revolutions the shaft has turned within a predefined sensing range, and this without the need of storing the rotational angle position when shutting off a device in which the method is used. The invention also relates to a device for deriving the absolute multiturn rotational angle by means of the method according to the invention.

A need for such a method can amongst others be found in power steering systems, and the present invention is especially provided for solving a problem in power steering systems of fork lift trucks. Many such applications use steering by wire, meaning that there is no mechanical connection between the means controlling the steering and the wheel to be steered. It is only an electric connection, and the driver controls the steering by means of a tiller arm or a steering wheel. If the steering is controlled by a tiller arm, it is necessary that the steering system has the ability to sense the angular position of the wheel to be steered. Also in the case the fork lift truck is provided with a steering wheel, and the driver/operator is riding on the fork lift truck, it is an advantage if the angular position of the wheel to be steered can be sensed since many such fork lift trucks have an indicator that is intended to show the angular position of the wheel to be steered, and then it is necessary to find out the correct position for this indicator when the fork lift truck is started.

In such a power steering usually a gearbox is provided for transmission of power from the motor to the shaft to be rotated. The output shaft from the gearbox then turns the wheel to be steered via a final gear. Generally in such power steering systems the gearbox output shaft (i.e. the input shaft to the final gear) has to be rotated several revolutions to provide one turn of the output shaft from the final gear. In such cases it is consequently not sufficient to sense only the angular position of the gearbox output shaft as it is not known in which of the several revolutions it is in. However, with a solution which gives the multiturn angle of the gearbox output shaft, such as the present invention suggests, there would be no need to measure/sense the angle of the final shaft, which can be a great advantage. It is usually easier to measure the angular position of the gearbox output shaft than of the final shaft.

From WO 2013/075796 A1 is previously known a rotational angle sensor for measuring the rotational angle of a shaft. This comprises a shaft provided with two code disks, the first code disk being rotationally fixed to the shaft while the second code disk is held between the shaft and the housing by two spring groups. Each code disk is assigned to a sensor. The sensor of the first code disk generates a periodic rotational angle signal while the sensor which is assigned to the second code disk generates a coarse signal which is different from the first signal and which can be used to ascertain which revolution of n possible revolutions the shaft is in, wherein n>1. One of the spring groups holding the second code disk comprises at least one spiral spring, allowing the shaft to rotate more than one revolution, but at the same time displacing the second code disk by turning it depending on the force in the spiral spring, wherein the force in the spiral spring and consequently the displacement of the second code disk is dependent on the number of revolutions performed. This kind of device naturally has a limit in the number of revolutions possible to perform, but a major drawback is that it requires a big number of additional parts to be able to measure the rotational angle.

From EP 1 386 124 B1 is known an absolute angle sensor for multi-turn shaft, wherein a wave generator having an elliptical shape is arranged to intermittently press a flex spline against an inner circular spline so that the circular spline only rotates at a proportional angle of rotation when the wave generator connected to a shaft is rotated a full revolution. It is thereby possible to determine the number of full revolutions performed by the shaft. A major drawback with this solution is that it requires additional parts which are subject to wear, to be able to measure the number of revolutions.

EP 2 662 660 A1 shows a rotation angle detection device for detecting an absolute rotation angle of a first rotating shaft in a transmission mechanism adapted to transmit from the first rotating shaft to the last of a number of rotating shafts. The transmission mechanism transmits revolution with a change ratio of (m±1)/m between each adjacent two of the rotating shafts. This is accomplished in that the transmission mechanism comprises a gear having m teeth which is meshed with a gear having (m±1) teeth between each adjacent two of the rotating shafts in the transmission mechanism. By this rotation detection device and the knowledge about the number of teeth, a multiturn rotation angle can be calculated.

A common problem with the known devices is that they require additional moving parts, which add to the construction costs, and moreover also are subject to wear and thereby possibly additional maintenance and replacement costs. Alternatively it is necessary to rotate the final shaft to a predefined calibration point.

EP 1 026 068 A2 shows and describes a system where two angles are measured on each side of a gearbox having a non-integer gear ratio, resulting in that the combination of the two angles reveal the angle of the slower rotating shaft within a range which is more than one turn. This system is intended for a car electric power assisted steering system, in which the steering wheel only has the possibility to be rotated a few full rotations.

The absolute multiturn rotational angle of the slower rotating outgoing shaft can easily be derived by analysing the combination of the angular positions of the at least two wheels or shafts in a power transmission line, hereafter referred to as a gearbox. For example, by analysing the angles of the input and output shafts of a gearbox with a gear ratio of 6.25:1 an absolute multiturn sensing range of four complete revolutions for the slower rotating gearbox output shaft is obtained.

However, such a system, where only two angles are measured, has limitations in how many turns sensing range that can be obtained without getting hard or impossible requirements on backlash and sensing accuracy for physical sensors, or by using gear ratios which in practice are not feasible for power transmission.

The above problems are according to the present invention solved by means of a method, and a corresponding device, wherein sensors are arranged to sense the absolute rotational angles of at least three wheels or shafts in a power transmission line having a gearbox with multiple stages with a non-integer gear ratio between the wheels/shafts in two or more of the stages. With this configuration the sensing range can be significantly extended without significantly increasing the accuracy requirements for the physical sensors and the backlash in the gearbox. For example a system based on a two-stage gearbox with the gear ratio of 6.75:1 in the first stage and 8.333333:1 in the second stage where the angles of all the three shafts are measured, gives a sensing range of 12 complete revolutions for the slowest rotating gearbox output shaft. The absolute multiturn rotational angle is derived by sensing the absolute rotational angles of at least three wheels or shafts, and analysing the combination of the sensed angles of the at least three wheels or shafts.

With the example gearbox given above (6.75:1 and 8.333333:1) all three shafts/wheels must be measured to obtain 12 revolutions sensing range. If only two shafts/wheels are measured, maximum 4 revolutions sensing range will be obtained.

The method according to the invention works with any kind of absolute angular sensors, for example magnetic sensors (e.g. Hall elements), inductive sensors, absolute encoders, resolvers, index pulse sensors, etc. Typically, one sensor would reveal the angle of a shaft/wheel within one revolution, but it must be notated that the present invention can work also with sensors which reveal the angle within segments of the shaft/wheel, e.g. a resolver with multiple pole pairs. However, this may require different gear ratios. The angular sensors output electric signals which by means of electric connections are transferred to an electronic circuit that based on the signals received can calculate first the absolute angular angles of the shafts, and then calculate the absolute multiturn rotational angle of the slowest rotating outgoing wheel or shaft, by analysing the combination of the rotational angles of the wheels or shafts, which are directly sensed/measured.

The invention will now be explained further by means of a couple of non-limiting examples, shown on the enclosed drawings, wherein

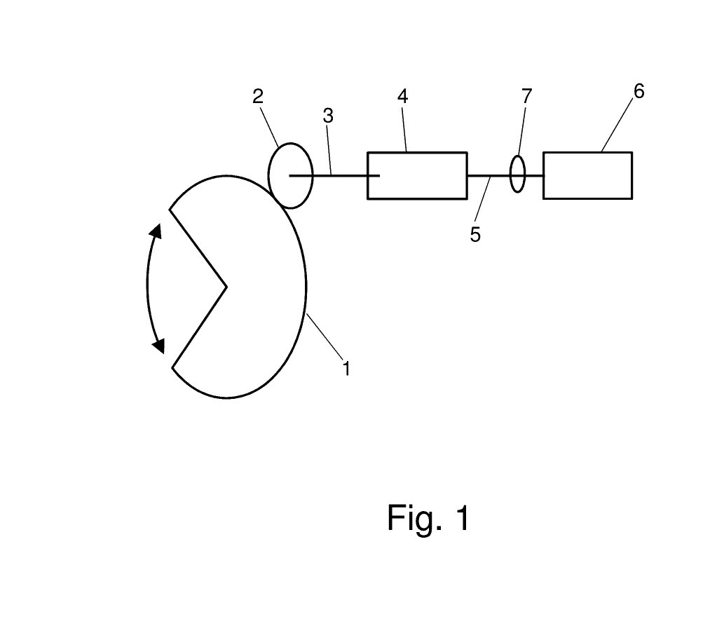

FIG. 1 shows a schematic perspective view of the for the invention essential parts of an electric power steering system of a lift truck,

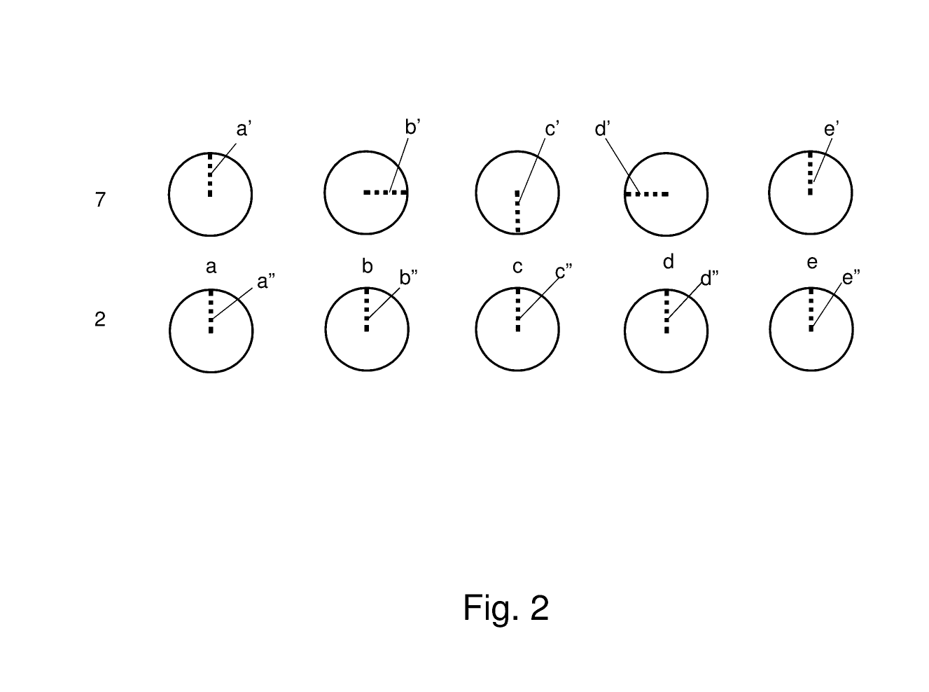

FIG. 2 shows a schematic drawing of wheel 7 and wheel 2 in FIG. 1 in different angular positions, and

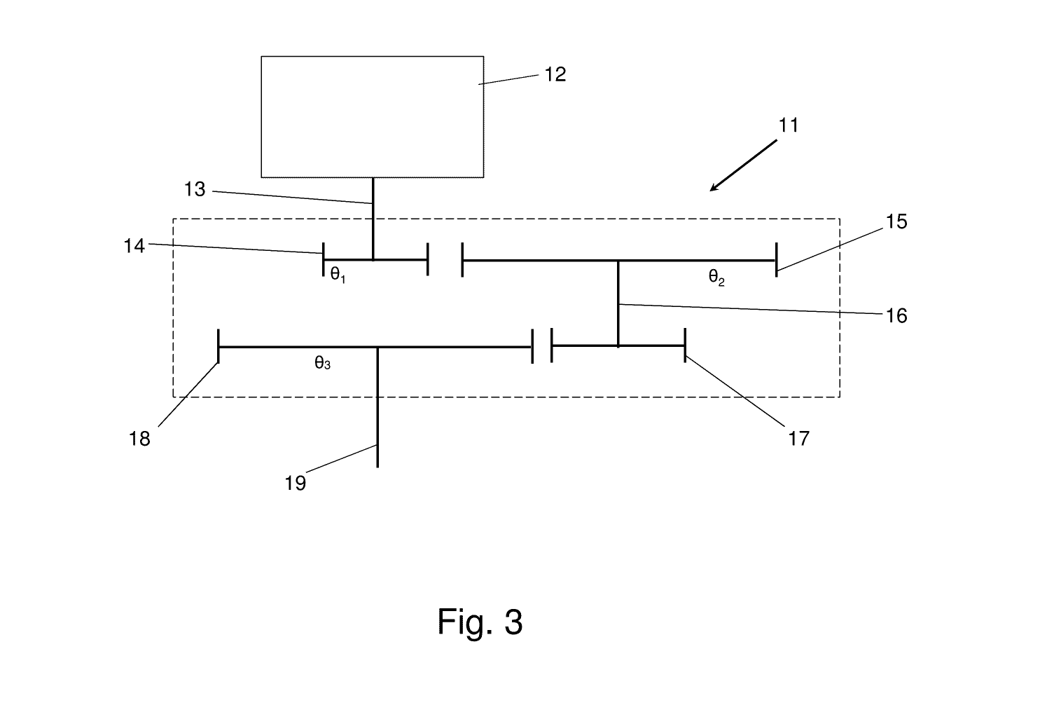

FIG. 3 shows a schematic view of a two stage gearbox.

The view shown in FIG. 1 thus shows a schematic perspective view of a steering system for a fork lift truck, the steering unit comprising a steering gear ring 1, directly connected to the wheel or wheels (not shown) to be steered on the fork lift truck. A gear wheel 2 connected to the steering gear ring 1 is mounted on an outgoing shaft 3 from a gearbox 4. The gears within the gearbox are driven by a drive shaft 5 which in turn is driven by an electric motor 6 arranged for the purpose of power steering of the fork lift truck. In the drawing is on the drive shaft 5 shown a wheel 7, which could represent either the rotor in the electric motor, or a gearwheel in the gearbox 4. For easier explanation it is here shown outside of the motor and gearbox.

For easier explanation, in this example, only two shafts/wheels are measured but the same or similar principle is used when three or more shafts/wheels are measured.

Angular sensors are arranged to sense the angular position of the gear wheel 2 as well as of the wheel 7. These angular positions correspond to the angular positions of the outgoing shaft 3 and the drive shaft 5, respectively, as the wheels 2 and 7 are rotationally fixed to the shafts 3 and 5. By choosing the gear ratio in the gearbox 4 so that the rotation of the wheel 7 is an non-integer multiple of the rotation of the gear wheel 2, sensing of the absolute rotational angles of wheel 7 and wheel 2, or shafts 3 and 5, can be used to exactly determine the number of revolutions of gear wheel 2/shaft 3, and thereby also the angular position of the steering gear ring 1, which in practice is the need to determine. The number of revolutions performed by the wheel 7 must consequently not be an integer multiple of number of revolutions performed by the gear wheel 2. This will further be explained with the help of FIG. 2.

FIG. 2 schematically shows two wheels in different angular combinations a-e. In the upper row is shown a wheel corresponding to the wheel 7 in different angular positions, shown by dashed lines a′-e′. In the lower row a wheel corresponding to the gear wheel 2 is shown in its angular positions corresponding to the angular positions a′-e′ of the wheel 7. The angular positions of the gear wheel 2 is also indicated by dashed lines a″-e″, thus in the view shown in the same position of 0°, but indicating different numbers of revolutions of the gear wheel 2. Position a″ corresponds to a starting point, 0 turns. Position b″ for the rotor wheel corresponds to 1 turn of the gear wheel 2, position c″ corresponds to 2 turns, position d″ corresponds to 3 turns and position e″ corresponds to 4 full turns or revolutions of the gear wheel 2. The gear ratio in the gearbox 4 is a non-integer, in this example chosen as 6.25:1, thus meaning that the rotor wheel 7 rotates 6.25 turns for each full turn or revolution of the gear wheel 2. This means that from the starting position where the rotor wheel has 0 turns, position a′, it has in position b′ 6.25 turns. Correspondingly in position c′ the rotor wheel 7 has performed 12.50 turns or revolutions, in position d′ 18.75 turns and finally in position e′ 25 full turns or revolutions.

From the schematic view in FIG. 2 can be realized that in positions a-d there is a unique combination of the angular positions of the two wheels, the rotor wheel 7 and the gear wheel 2. In position e it is the same situation as in position a, so the rotor wheel shall not be allowed to perform so many full turns, thus the number of full turns allowed has to be under 4 for gear wheel 2 if it shall be possible to sense the absolute multiturn rotation of the wheel 2/shaft 3. However, if the gear ratio between wheel 2 and the steering gear ring 1 is properly selected (in the present example it could be 4:1 or 2:1) and steering gear ring 1 would allow endless rotation, there would be no limitation in how many turns wheel 2 could be rotated, since the multiturn angle of wheel 2 (i.e. 0°-1440°) would always reveal the absolute angle of the steering gear ring 1. So, for such a system, endless rotation would be allowed, and the rotational angle of steering gear ring 1 would always be known.

Power steering of a fork lift truck is a good example of an application where the invention could be beneficial, but the method and device according to the invention could of course also be used for any application, where a multiturn sensing function of a shaft is desired, for example for linear positioning.

In FIG. 3 is shown a schematic practical example of how the invention can be used with a two stage gearbox 11. A motor 12 is arranged driving a motor shaft 13 which is the input shaft to the gearbox 11, and is connected to a first gear wheel 14 inside the gearbox. This first gear wheel 14 is connected to and into engagement with a second gear wheel 15. The gear ratio between the first and second gear wheels 14 and 15 is 6.75:1. The second gear wheel 15 is mounted on one end of an internal shaft 16 inside the gearbox. This internal shaft 16 is at its other end provided with a third gear wheel 17. This third gear wheel 17 is in engagement with a fourth gear wheel 18 inside the gearbox. The gear ratio between gear wheel 17 and gear wheel 18 is 8.333333:1. The fourth gear wheel 18 is in turn mounted on one end of an output shaft 19 being the output shaft from the gearbox 11.

Within the gearbox 11 angle sensors are mounted on the first, second and fourth gear wheels 14, 15 and 18, to sense the angle θ₁ of the motor shaft 13, the angle θ₂ of the internal shaft 16 and the angle θ₃ of the output shaft 19. The angle of the motor shaft 13 would, however, typically be measured by a sensor in the motor. The angles θ₁, θ₂ and θ₃ can be directly sensed by sensors and by analysing the combination of these three angles the number of turns of the output shaft 19 can be derived within a range of 12 turns, given the gear ratios described above.

For this example of a gearbox all three angles, θ₃, θ₂, θ₁, must be measured to obtain 12 turns sensing range. The total sensing accuracy required (sum of inaccuracy of the physical sensors, backlash in gearing and other imperfections) is about ±6°.

A multiturn sensing system with 12 turns sensing range, and approximately the same total gear ratio can in theory be obtained with a single stage gearbox. For example a single stage gearbox with total gear ratio of 56.083333:1, where two angles are measured would in theory give 12 turns sensing range, but the total required accuracy for physical sensors (sum of inaccuracy of physical sensors, backlash in gearing and other imperfections) is for this system about ±0.3°, which in practice is very hard or impossible to achieve.

As described above, by using a non-integer gear ratio between two gear wheels an absolute multiturn angle of the slower moving gear wheel can be derived by analysing the combination of the angles of both wheels. By using a gearbox with multiple stages the sensing range can be significantly extended without increasing accuracy requirements for the physical sensors and increasing requirements on backlash.

The gearbox used can be any kind of gearbox which can provide the desired gear ratio, e.g. epicyclical (planetary), spur gears, worm gears, gearing by chain, belt etc.

As can be seen above, a multiturn sensing system, can be used in a fork lift truck, to reveal the absolute angle of the final steering gear ring 1 in the fork lift truck, since the multiturn angle (angle over several turns) of shaft 3/wheel 2 is known. Obviously, the sensing range of shaft 3/wheel 2 must exceed the number of revolutions that shaft 3/wheel 2 turns when the truck is steered from full left to full right.

However, in some lift trucks, the final steering gear ring 1 can rotate endlessly in any direction. Also in such a configuration, the multiturn system can be used, provided that the gear ratio in the final gear stage (between wheel 1 and wheel 2) is selected properly. This gear ratio must be matched with the sensing range of the multiturn sensing system, so that when wheel 2/shaft 3 has turned over its entire sensing range, wheel 1 must have turned one or several complete turns, and therefore is be back in its initial position/angle.

For example, if the multiturn sensing system has a sensing range of 12 revolutions for wheel 2/shaft 3, the final gear ratio (between wheel 1 and wheel 2) could for example be 1:4. When the sensing system has rotated over its entire sensing range, i.e. wheel 2/shaft 3 has rotated 12 turns, wheel 1 has then rotated exactly 3 turns, and is back in its initial angle.

From this can be understood that some sensing ranges give more possibilities than others. For example, a steering unit/system consisting of parts 2,3,4,5,6,7, with a sensing range of 12 turns for wheel 2/shaft 3, can be used in lift trucks (or other applications) with final gear ratios of 1:3, 1:4 and 1:6, if it is assumed that only this interval (1:3 to 1:6) is of interest. A similar unit/system with a sensing range of 4 turns for wheel 2/shaft 3 would only allow for a final gear ratio of 1:4 in the same interval.

Since greater sensing ranges (more revolutions) typically give more possibilities for having different final gear ratios in the application, it is beneficial to use gearboxes with multiple stages, where three or more angles are measured, since such systems typically give greater sensing ranges than systems where only two angles are measured.

With the present invention an absolute multiturn system is obtained, wherein the multi-turn sensing function is derived from sensed angles of shafts/gear wheels in a gearbox, where the gearbox also is used for power transmission. In addition to the parts used for the power transmission no further moving parts has to be added to achieve the absolute multiturn sensing function. Only sensors of some kind have to be added, as well as some kind of calculating and analysing means, such as an electronic circuit or computer provided with logics which can calculate/derive the absolute multiturn angle/position from signals received from the sensors. The calculating and analysing means can preferably be integrated within the means provided for other control for example for running a motor.

1-13. (canceled)

14. A method for deriving an absolute multiturn rotational angle of a rotating shaft (3; 19), wherein sensors are arranged to sense the absolute rotational angles of wheels (2, 7; 14, 15, 18) or shafts (3, 5; 13, 16, 19) in a power transmission line (4; 11) having an non-integer gear ratio between the wheels/shafts, whereby an absolute multiturn rotational angle of the output shaft from the transmission line is derived by sensing the absolute rotational angles of the wheels (2, 7; 14, 15, 18) or shafts (3, 5; 13, 16, 19), and analyzing the combination of the sensed angles of the wheels or shafts and thereby deriving the absolute multiturn rotational angle based on the rotational angles read by the sensors, wherein the power transmission line comprises a gearbox (11) having multiple stages and wherein the rotational angles are sensed on at least three wheels (14, 15, 18) or shafts (13, 16, 19) in different stages, whereby the absolute multiturn rotational angle of the output shaft (19) can be derived based on the rotational angles of the wheels (14, 15, 18) or shafts (13, 16, 19) sensed.

15. The method according to claim 14, wherein the sensor is an element sensing the rotational angle of a wheel or shaft transmitting power within the power transmission line.

16. The method according to claim 14, wherein the gearbox (4; 11) is also used for power transmission to a wheel to be steered.

17. The method according to claim 14, wherein the method is comprised in a steering device for a steerable wheel.

18. A device for deriving an absolute multiturn rotational angle of a multiturn rotating shaft (3; 19), wherein sensors are arranged to sense the rotational angles of wheels (2, 7; 14, 15, 18) or shafts (3, 5; 13, 16, 19) in a power transmission line (4; 11) having an non-integer gear ratio between the wheels/shafts, and the absolute multiturn rotational angle of the output shaft from the power transmission line (4; 11) is derived by sensing the rotational angles of the wheels or shafts, whereby the absolute multiturn rotational angle of the output shaft from the transmission line is derived by a calculating means analyzing the combination the rotational angles of the wheels (2, 7; 14, 15, 18) or shafts (3, 5; 13, 16, 19), and thereby deriving the absolute multiturn rotational angle based on the rotational angles read by the sensors wherein the power transmission line comprises a gearbox (11) provided with multiple stages and sensors are arranged to sense the rotational angle on at least three wheels (14, 15, 18) or shafts (13, 16, 19) in different stages, and whereby the absolute multiturn rotational angle of the output shaft is derived based on the rotational angles of the wheels (14, 15, 18) or shafts (13, 16, 19) sensed.

19. The device according to claim 18, wherein the sensor is an element arranged to sensing the rotational angle of a wheel or shaft transmitting power in the gearbox.

20. The device according to claim 19, wherein the gearbox (4; 11) is a gearbox used for power transmission.

21. The device according to claim 18, wherein the power transmission line is part of a steering device (1) for a steerable wheel.

22. The device according to claim 18, wherein the calculating means is an electronic circuit or computer provided with logics to calculate the absolute multiturn rotational angle of the output shaft (3; 19).

23. The device according to claim 22, wherein the logics are integrated with logics used for other controls, e.g. running a motor or running and supervising a steering device.

24. The device according to claim 18, wherein the device is arranged in a fork lift truck.

25. The device according to claim 21, wherein the steering device is an endlessly rotatable steering gear ring (1).

26. The device according to claim 18, wherein a multiturn sensing range is matched with the final gear ratio so that the final gear ring (1) can rotate endlessly and the angle of the final gear ring is always known.

27. The device according to claim 26, wherein the multiturn sensing range is 12 for a first shaft (3) matched with a final gear ratio of 1:3, 1:4 or 1:6 of the final gear ring (1).

28. The method according to claim 14, wherein a multiturn sensing range is matched with the final gear ratio so that the final gear ring (1) can rotate endlessly and the angle of the final gear ring is always known.

29. The method according to claim 28, wherein the multiturn sensing range is 12 for a first shaft (3) matched with a final gear ratio of 1:3, 1:4 or 1:6 of the final gear ring (1).
